(19) United States
(12) Patent Application Publication
(10) Pub. No.: US 2013/0024283 A1
(43) Pub. Date: Jan. 24, 2013

(54) Using per document or document type performance of ad configurations in ad serving decisions

(71) Applicants: Brian Axe, San Francisco, CA (US); Shannon Bauman, Mountain View, CA (US)

(72) Inventors: Brian Axe, San Francisco, CA (US); Shannon Bauman, Mountain View, CA (US)

(21) Appl. No.: 11/823,924

(22) Filed: Jun. 27, 2007

Related U.S. Application Data
(63) Continuation-in-part of application No. 10/895,026, filed on Jul. 20, 2004.

(51) Int. Cl. G06Q 30/00; G06Q 10/00

(52) U.S. Cl. 705/14.54

(57) ABSTRACT

An ad configuration that works well (or best) for a given document or a given type of document is determined and/or used. For example, advertisements having different advertisement configurations may be served with different instances of a given document of a document type. Performance of the different advertisement configurations for at least one of the given document and document type may be tracked. A preferred advertisement configuration for at least one of the given document and document type may then be determined using the tracked performance of the different advertisement configurations. Finally, the determined preferred advertisement configuration may be associated with the at least one of a given document and document type. Once such an association has been determined (or accepted), document information of a document to be provided with advertisements may be accepted, and a document type of the document may be determined using the document information. The preferred advertisement configuration associated with the determined document type may then be determined, and advertisements may be served with the document in accordance with the determined preferred ad configuration.

### CROSS-REFERENCE TO RELATED APPLICATIONS

The present application is a continuation-in-part of U.S. patent application Ser. No. 10/895,026 filed Jul. 20, 2004.

### BACKGROUND OF THE INVENTION

1. Field of the Invention

The present invention concerns serving advertisements (“ads”), such as serving ads in an online environment. In particular, the present invention concerns improving an ad configuration or finding the optimal ad configuration (e.g., the one expected to yield an increase in revenue or the maximum revenue) per document or document type.

2. Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.) Query keyword relevant advertising, such as the AdWords advertising system by Google of Mountain View, Calif. (referred to as “Google”), has been used by search engines. Similarly, content-relevant advertising systems have been proposed. For example, U.S. patent application Ser. Nos. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and 10/375,900 (incorporated by reference and referred to as “the '900 application”) titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. The AdSense advertising system by Google is an example of a content targeted ad delivery system used to serve ads on Web pages.

Current systems for serving targeted text ads may auction or arbitrate a given number of “spots” on a document (e.g., a Web page instance) to competing ads. Such spots typically specify a particular type of ad that may be served. For example, a search result Web page might have two (2) wide-format, text ad spots at the top of the Web page and eight (8) normal-format text ad spots in the right column of the Web page. There may be more than two (2) ads competing to be served in the two (2) wide-format text ad spots and more than eight (8) ads competing to be served in the eight (8) normal-format text ad spots. Ad serving facilities may arbitrate each ad spot to competing ads using an auction model. For example, competing ads can be placed in available ad spots using a bid price (associated with each ad) only. As another example, competing ads can be placed in available ad spots using some combination of an offer price, ad performance (e.g., in terms of selection rate, user ratings, conversion rate, etc.), and/or ad relevancy.

Regardless of the arbitration technique used, generally, all available ad spots are filled (to the extent that there are enough ads available to fill them). However, there may be some instances in which a policy of filling all available ad spots, if possible or to the greatest extent possible, might not be desirable from the standpoint of the end user, the Web page owner or publisher, and/or the ad serving facility. (See, e.g., U.S. patent application Ser. No. 11/169,323 (incorporated herein by reference and referred to as “the '323 application”) titled, “USING THE UTILITY OF CONFIGURATIONS IN AD SERVING DECISIONS,” filed on June 28, 2005, and listing Amit PATEL and Hal VARIAN, as the inventors; and U.S. patent application Ser. No. 11/396,300 (incorporated herein by reference and referred to as “the '300 application”), titled “DYNAMICALLY RESIZING OR OTHERWISE ALTERING AD CREATIVES AND/OR DETERMINING NUMBER OF ADS TO IMPROVE SCORE OF SET OF ONE OR MORE ADS AS AN AD UNIT,” filed on Mar. 31, 2006, and listing Jeff EDDINGS, Gokul Rajaram, and Scott Benson, as the inventors.)

Although the '323 and '300 applications describe techniques to optimize or at least improve ad configurations, the present inventors believe that an ad configuration that works well for one document or type of document, might not work well for another document or type of document. Thus, it would be useful to further improve ad serving decisions.

### SUMMARY OF THE INVENTION

An ad configuration that works well (or best) for a given document or a given type of document is determined and/or used. For example, advertisements having different advertisement configurations may be served with different instances of a given document of a document type. Performance of the different advertisement configurations for at least one of the given document and document type may be tracked. A preferred advertisement configuration for at least one of the given document and document type may then be determined using the tracked performance of the different advertisement configurations. Finally, the determined preferred advertisement configuration may be associated with the at least one of a given document and document type.

Once such an association has been determined (or accepted), document information of a document to be provided with advertisements may be accepted, and a document type of the document may be determined using the document information. The preferred advertisement configuration associated with the determined document type may then be determined, and advertisements may be served with the document in accordance with the determined preferred ad configuration.

### BRIEF DESCRIPTION OF THE DRAWINGS

FIG. 1 is a high-level diagram showing parties or entities that can interact with an advertising system.

FIG. 2 is a diagram illustrating an exemplary environment in which, or with which, embodiments consistent with the present invention may operate.

FIG. 3 is a bubble diagram illustrating operations that may be performed, and information that may be used and/or generated, in a manner consistent with the present invention.

FIG. 4 is a flow diagram of an exemplary method for determining a preferred advertisement configuration for a given document or document type, in a manner consistent with the present invention.

FIG. 5 is an exemplary data structure for storing page or page type serve and user-ad interaction log information, in a manner consistent with the present invention.

FIG. 6 is an exemplary data structure for storing page or page type ad configuration performance information, in a manner consistent with the present invention.

FIG. 7 is an exemplary data structure for storing page per page or page type preferred ad configuration information, in a manner consistent with the present invention.

FIG. 8 is a flow diagram of an exemplary method for determining a preferred advertisement configuration for a given document, in a manner consistent with the present invention.

FIG. 9 is a flow diagram of an exemplary method for determining a preferred advertisement configuration for a given document type, in a manner consistent with the present invention.

FIG. 10 is a block diagram of exemplary apparatus that may perform various operations and store various information, in a manner consistent with the present invention.

### DETAILED DESCRIPTION

The present invention may involve novel methods, apparatus, message formats, and/or data structures for determining, and/or using, an ad configuration improved or optimized (e.g., yielding an increased or maximum revenue) per document, or per document type. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

In the following, definitions of terms that may be used in the specification are set forth in §4.1. Then, environments in which, or with which, embodiments consistent with the present invention may operate are described in §4.2. Then, exemplary embodiments consistent with the present invention are described in §4.3. Finally, some conclusions regarding the present invention are set forth in §4.4.

### DEFINITIONS

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a characteristic of a user (e.g., their geographic location, the language used by the user, the type of browser used, previous page views, previous behavior, user account, any Web cookies used by the system, user device characteristics, etc.) to whom the ad was served, a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the present invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document, on which or with which the ad is to be served, includes certain topics or concepts, or falls under a particular cluster or clusters, or some other classification or classifications (e.g., product and/or service verticals). In some systems, an advertiser may specify that its ad is to be served only to (or is not to be served to) user devices having certain characteristics. Finally, in some systems, an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., click-throughs) of an ad to the number of impressions of the ad (i.e., the number of times an ad is rendered) is defined as the “selection rate” (or “click-through rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered), and the ratio of the number of conversions to the number of selections (or the number of some other event), are both referred to as the “conversion rate.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “property” is something on which ads can be presented. A property may include online content (e.g., a Website, an MP3 audio program, online games, etc.), offline content (e.g., a newspaper, a magazine, a theatrical production, a concert, a sports event, etc.), and/or offline objects (e.g., a billboard, a stadium score board, and outfield wall, the side of truck trailer, etc.). Properties with content (e.g., magazines, newspapers, Websites, email messages, etc.) may be referred to as “media properties.” Although properties may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.).

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

A “Web document” includes any document published on the Web. Examples of Web documents include, for example, a Website or a Web page.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a media property (e.g., document). A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

An “ad area” may be used to describe an area (e.g., spatial and/or temporal) of a document reserved or made available to accommodate the rendering of ads. For example, Web pages often allocate a number of spots where ads can be rendered, referred to as “ad spots”. As another example, an audio program may allocate “ad time slots,” which may be thought of more generally as “ad spots.”

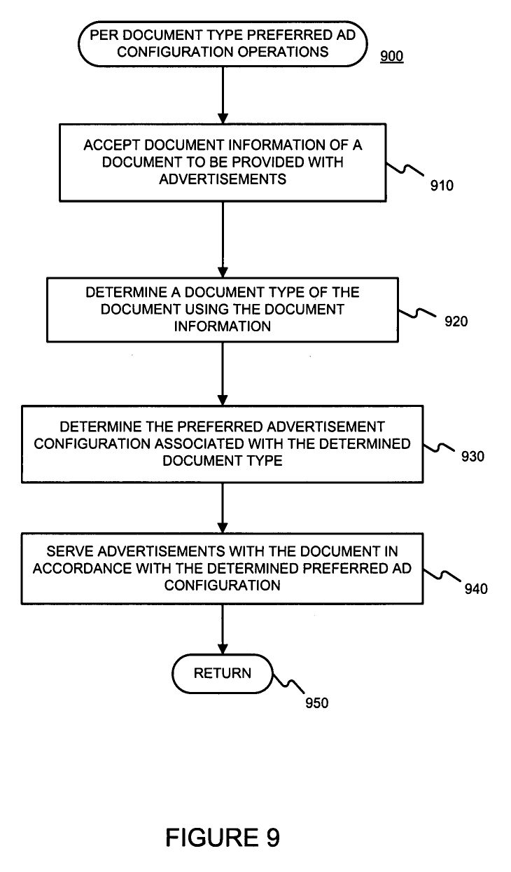

A combination of an ad's parameters (e.g., size, color, font, brightness, style, etc.), its spatial and/or temporal position, its frequency, etc. may be referred to as the ad's “treatment.” Thus, “treatment” can be used to described characteristics of the rendering (e.g., display) of an ad. The way in which ads with different treatments can be determined from common “seed” information is illustrated in an example described in §4.4 and FIG. 9 of the '323 application.

In the following, a “configuration” is defined to be a description of a set of ad participants (which may be served with a document). It is possible to generate different ad participants from common “seed” information. For example, creative text may be used as seed information to generate ads of different sizes, colors, fonts, brightnesses, etc. (which may be referred to as ad “parameters” or ad “formats”). Further, a given ad participant may be placed in different spatial and/or temporal positions (e.g., ad spots) in different configurations. Furthermore, a given ad participant may be placed with different frequencies in different configurations. Thus, a “configuration” may be used to describe a set of ads, and their associated treatments, to be placed on, or otherwise rendered in association with, a document. Note that the same set of ads may be described by different configurations if the ads have different treatments.

### Exemplary Environments In Which, Or With Which, Embodiments Consistent With the Present Invention May Operate

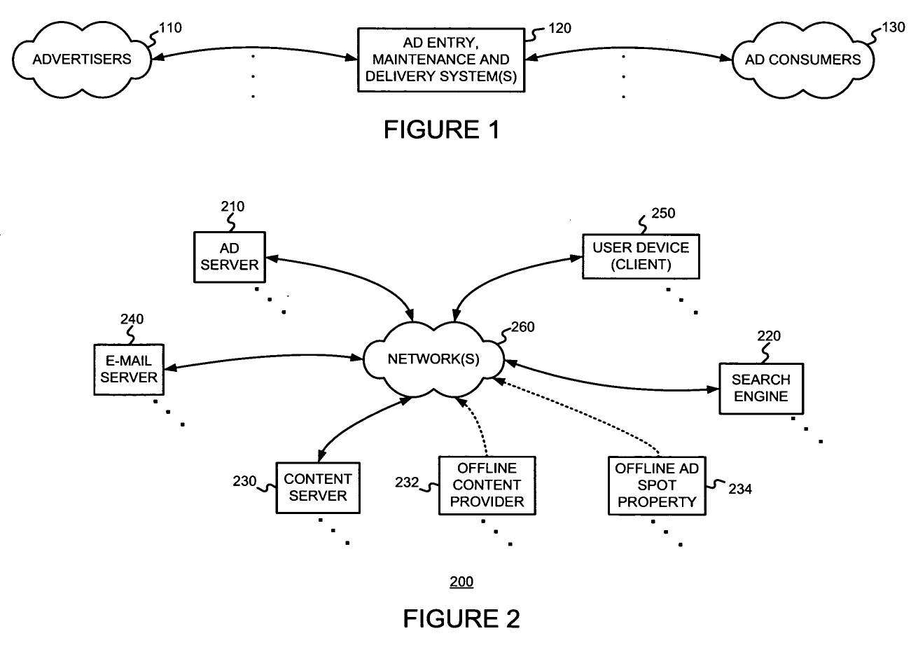

FIG. 1 is a high-level diagram of an advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text-only ads, image ads, audio ads, animation ads, video ads, ads combining one of more of any of such components, etc. The ads may also include embedded information, such as a link, and/or machine executable instructions. Ad consumers 130 may submit requests for ads to the system 120, accept ads responsive to their request from the system 120, and provide usage information to, the system 120. An entity other than an ad consumer 130 may initiate a request for ads. Although not shown, other entities may provide usage information (e.g., whether or not a conversion or selection related to the ad occurred) to the system 120. This usage information may include measured or observed user behavior related to ads that have been served.

The ad server 120 may be similar to the one described in FIG. 2 of the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, geolocation information, user profile information, etc.), and price information (e.g., a maximum cost or offer per selection, a maximum cost or offer per conversion, a cost or offer per selection, a cost or offer per conversion, etc.). Alternatively, or in addition, each ad group may include an average cost (e.g., average cost per selection, average cost per conversion, etc.). Therefore, a single maximum cost, a single cost, and/or a single average cost may be associated with one or more keywords, and/or topics. As stated, each ad group may have one or more ads or “creatives” (that is, ad content that is ultimately rendered to an end user). Each ad may also include a link to a URL (e.g., a landing Web page, such as the home page of an advertiser, or a Web page associated with a particular product or service). Naturally, the ad information may include more or less information, and may be organized in a number of different ways.

FIG. 2 illustrates an environment 200 in which, or with which, embodiments consistent with the present invention may be used. A user device (also referred to as a “client” or “client device”) 250 may include a browser facility (such as the Firefox browser from Mozilla, the Explorer browser from Microsoft, the Opera Web Browser from Opera Software of Norway, the Navigator browser from AOL/Time Warner, etc.), some other content rendering facility, an e-mail facility (e.g., Outlook from Microsoft), etc. A search engine 220 may permit user devices 250 to search collections of documents (e.g., Web pages). A content server 220 may permit user devices 250 to access documents. An e-mail server (such as Gmail from Google, Hotmail from Microsoft Network, Yahoo Mail, etc.) 240 may be used to provide e-mail functionality to user devices 250. An ad server 210 may be used to serve ads to user devices 250. For example, the ads may be served in association with search results provided by the search engine 220. Alternatively, or in addition, content-relevant ads may be served in association with content provided by the content server 230, and/or e-mail supported by the e-mail server 240 and/or user device e-mail facilities.

As discussed in the '900 application, ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired (or the number of available ad spots). The ad request may also include document request information. This information may include the document itself (e.g., a Web page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, etc.) back to the ad server 120/210. Alternatively, or in addition, such information may be provided back to the ad server 120/210 by some other means.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired (or the number of available ad spots). This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate, and/or as described below, information related to, and/or derived from, the search query), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, click-through or not, impression time, impression date, size, conversion or not, etc.) back to the ad server 120/210. Such information may include information for determining on what basis the ad was determined to be relevant (e.g., strict or relaxed match, or exact, phrase, or broad match, etc.). Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under, over, or otherwise in association with an e-mail.

Although the foregoing examples described servers as (i) requesting ads, and (ii) combining them with content, one or both of these operations may be performed by a client device (such as an end user computer for example).

### Exemplary Embodiments

Embodiments consistent with the present invention may be used to determine and/or use an improved (e.g., optimum) ad configuration for serving with a given document or document type. (Note, however, that the types and numbers of ads that may be served with a document may be determined in a number of different ways, and need not be determined solely by the document, or solely by the document type.)

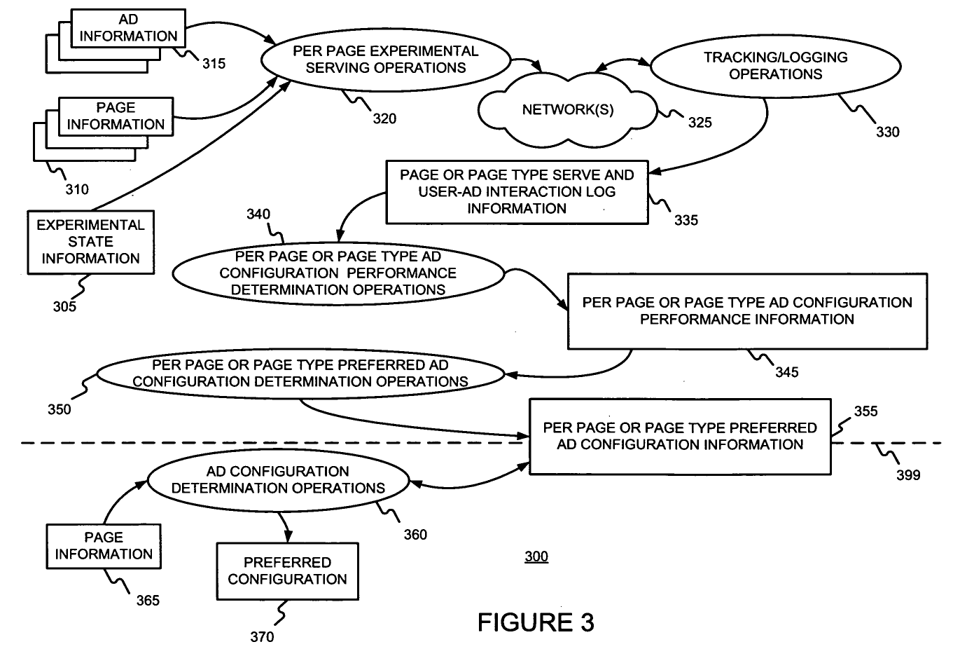

FIG. 3 is a bubble diagram illustrating operations that may be performed, and information that may be used and/or generated, in a manner consistent with the present invention. As shown in FIG. 3, ad information 315, page information 310, and experimental state information 305 are provided to per page experimental serving operations 320. Tracking/logging operations 330 may process information, part of which is produced by the per page experimental serving operations 320, which is obtained through the network(s) 325. The processed information generated by the tracking/logging operations 330 may be stored as page or page type serve and user-ad interaction log information 335. Per page or page type ad configuration performance determination operations 340 may use this information 335 to generate per page or page type ad configuration performance information 345. Per page or page type preferred ad configuration determination operations 350 may use this information 345 to generate per page or page type preferred ad configuration information 355. Ad configuration determination operations 360 may use page information 365, as well as the per page or page type preferred ad configuration information 355, to determine a preferred ad configuration 370 for the page to which information 365 pertains.

The pages may be Web pages, collections of Web pages (e.g., a Website), or some other document(s).

In some embodiments consistent with the present invention, one or more of the operations introduced above might be “components” of a system or apparatus. For example, one or more of the operations introduced above might be modules of computer-executable instructions, and an exemplary system or apparatus consistent with the present invention might include storage device(s) to store the modules of computer-executable instructions, and/or input means to receive the modules of computer-executable instructions. Alternatively, at least some of the components might be implemented as hardware or firmware.

The per page experimental serving operations 320 may be used to help learn how different ad configurations and/or types of ad configurations perform on different documents and/or types of documents. Thus, when ads 315 are to be served on pages 310, the operations 320 can be used to vary ad configurations for a given page or type of page, using the experimental state information 310. Page information 310 may include the genre of the content on the page (e.g., news site, blog, forum, etc.), the placement of the various ad blocks (e.g., above the fold, below the fold, left margin, right margin, top margin, etc.), the dominant font type of the page, the background color or background image of the page, the dominant font color of the page, the dominant font size of the page, number of images or total pixel count of images on the page, the location of other elements in the page (e.g., main navigation, the main content, etc.), the technology used on the page (e.g., javascript, Macromedia flash, video, etc).

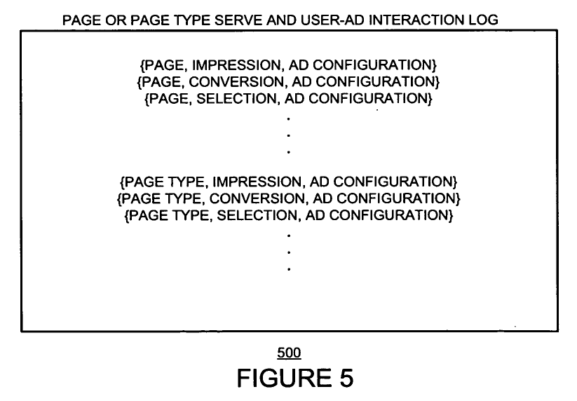

The tracking/logging operations 330 may generate page or page type serve and user-ad interaction log information 335. For example, FIG. 5 is an exemplary data structure 500 for storing page or page type serve and user-ad interaction log information in a manner consistent with the present invention. As shown, information tracked and logged per page or page type might include ad impressions, ad conversions, and/or ad selections, together with the associated ad configurations.

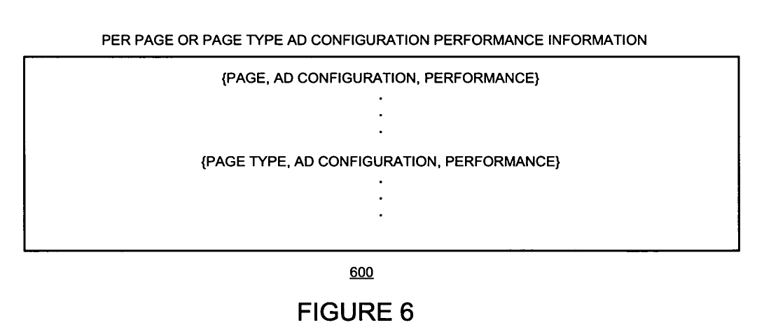

Referring back to FIG. 3, the per page or page type ad configuration performance determination operations 340 may generate per page or page type ad configuration performance information 345. For example, FIG. 6 is an exemplary data structure 600 for storing performance information per page or page type, ad configuration pair (i.e., per {page, ad configuration} or {page type, ad configuration} pair) in a manner consistent with the present invention. The performance for each {page or page type, ad configuration} pair might include one or more of a selection rate (e.g., click-through rate), a conversion rate, a revenue amount (e.g., a collective, per page impression, ad revenue amount), etc. Operations 340 might derive such performance information 345 from log information 335.

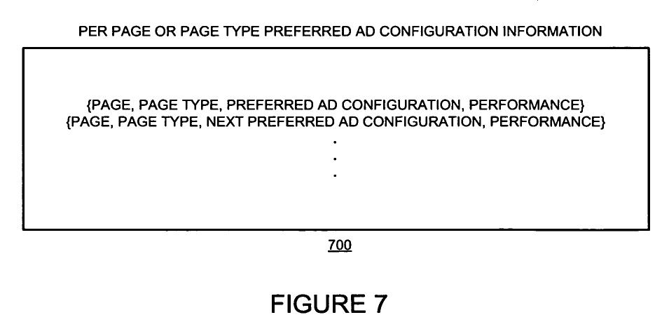

The per page or page type preferred ad configuration determination operations 350 may generate per page or page type preferred ad configuration information 355. For example, FIG. 7 is an exemplary data structure 700 for storing per page or page type preferred ad configuration information in a manner consistent with the present invention. Data structure 700 may be a table with plurality of entries. Each of the plurality of entries might be keyed by a page and/or page type identifier. Some of the entries might include a preferred ad configuration and perhaps its associated performance. Other entries might include less preferred ad configurations in a descending order.

The operations and information above the dashed line 399 may be thought of as a “predictive engine” that and analyzes performance information for various {page, ad configuration), and/or {page type, ad configuration) pairs to determine which ad configuration is expected to work best for a given page or page type. To summarize, multiple different formatting options (i.e., different ad configurations) may be used for a given ad block for various impressions of a given page or page type. The performances of the different ad configurations are determined. Thus, the system might try out various combinations of formatting options (i.e., different ad configurations) to determine what the best (e.g., best performing) ad configuration should be for a given page or a given page type. This data may also be fed back into the “predictive engine” system in order to supply more data for future decision making on new pages. Ad configurations might be defined by values or value ranges for one or more of number of ads, type of ads (image, text, links, multimedia, etc.), size of ad block, background color of ads, background image of the ads, text size of ads, text color of ads, font type of ads, border width of ads or ad block, border color of ads or ad block, video, animation or audio segments for the advertisement, length (e.g., amount of text or time of display) or size of ad creative, whether or not the ad(s) include maps, whether or not the ad(s) includes an accompanying image(s), whether or not the ad(s) includes dynamic functionality (e.g., roll-over text, video, audio or images), whether or not the ad(s) includes interaction with other aspects of the ad block (e.g., clicking links in one part of the ad block resulting in new ads in a different part of the ad block), whether or not the ad(s) includes text decoration, text underlining, bold text, italics, spacing, etc., etc.

Thus, in FIG. 3, the operations above the dashed line 399 have generated preferred ad configuration information 355 for a number of pages and/or page types. This 355 information may be used by the ad configuration determination operations 360 in order to determine a preferred ad configuration 370 given page information 365 (e.g., a page identifier, a page type identifier, information from which a page type identifier can be derived, etc.) Note that a page type might be defined by a feature vector expressing attributes of the page.

### Exemplary Methods

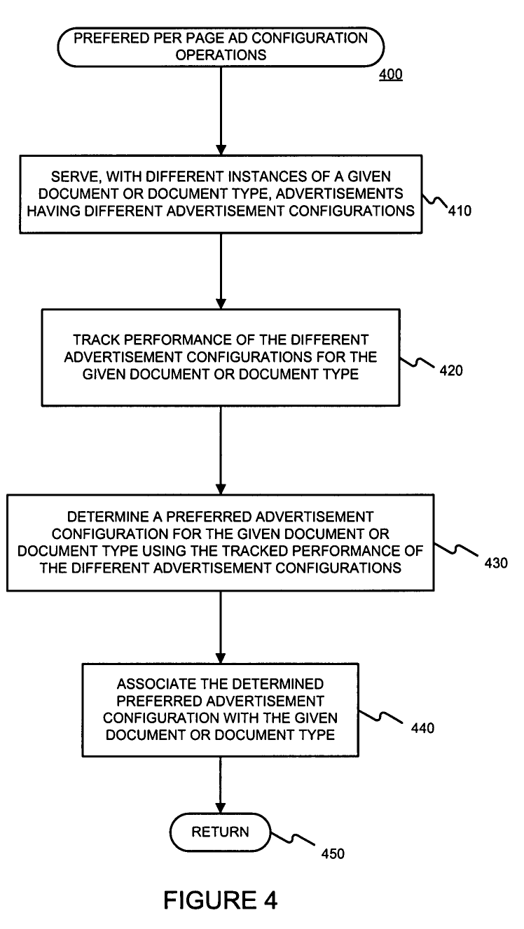

FIG. 4 is a flow diagram of an exemplary method 400 for determining, in a manner consistent with the present invention, a preferred advertisement configuration for a given document or document type. Specifically, the method 400 may initially serve, with different instances of a given document, or with different instances of a given document type, advertisements having different advertisement configurations. (Block 410) The method 400 may track the performance of the different advertisement configurations for the given document or for the given document type. (Block 420) Using the tracked performance of the different advertisement configurations, the method 400 may determine a preferred advertisement configuration for the given document or document type. (Block 430) Finally, the method 400 may associate the determined preferred advertisement configuration with the given document or document type (Block 440) before the method 400 is left (Node 450).

Referring back to block 410, experimental state information 305 might be used to ensure that different ad configurations are tried for a given page or page type during an experiment. For example, if only one ad configuration was used for a page type during an experiment, the system would not be able to discover whether such an ad configuration is better or worse, for the page type, than untried ad configurations.

Referring back to 420, the tracked performance might be selection rates, conversion rates, etc. (Recall, e.g., FIGS. 5 and 6.). The performance might be a performance score determined using one or more of the foregoing tracked performance metrics.

Referring back to block 430 the preferred ad configuration for a page or page type might be the one with the best performance (e.g., in terms of selection rate, click-through rate, revenue amount (e.g., a collective, per page impression, ad revenue amount), etc.), or the best performance score.

Finally, referring back to block 440, the preferred configuration might be stored in association with a page and/or a page type. (Recall, e.g., exemplary data structure 700 of FIG. 7.) The performance value or values, and/or a performance score, may also be stored.

The method 400 may be used to perform the operations 320, 330, 340 and 350 of FIG. 3.

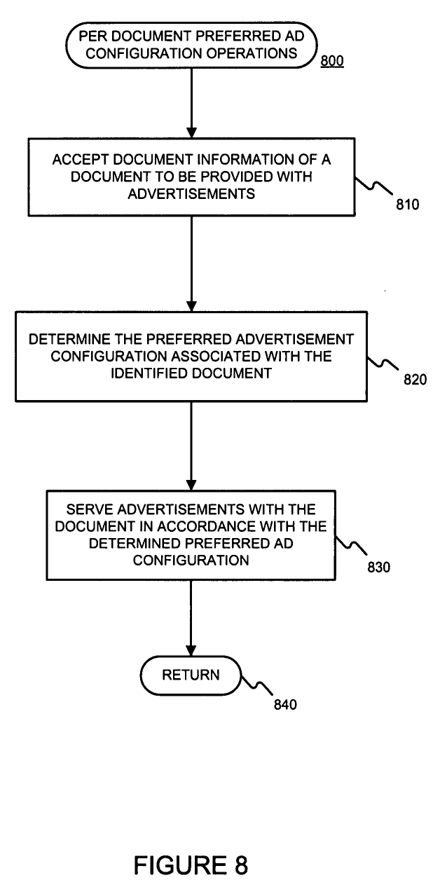

FIG. 8 is a flow diagram of an exemplary method 800 for determining, in a manner consistent with the present invention, a preferred advertisement configuration for a given document. Specifically, the method 800 may accept document information of a document to be provided with advertisements. (Block 810) Next, the method 800 may determine the preferred advertisement configuration associated with the identified document or determined document type. (Block 820) Finally, the method 800 may serve advertisements with the document in accordance with the determined preferred ad configuration (Block 830) before the method 800 is left (Node 840).

Referring back to block 820, a document type might be derived from features of an input document using known and/or proprietary classification techniques. Document types might include news, blogs, forum, user rating, entertainment, search results, video search results, image search results, audio search results, e-mail search results, universal search results, gaming, social network, commerce and online encyclopedia (e.g., a WIKI), etc.

Still referring to block 820, the preferred ad configuration might be looked up in a table (Recall, e.g., data structure 700 of FIG. 7.) using the document and/or document type as a key.

FIG. 9 is a flow diagram of an exemplary method 900 for determining, in a manner consistent with the present invention, a preferred advertisement configuration for a given document type. In particular, the method 900 may accept document information of a document to be provided with advertisements. (Block 910) Next, the method 900 may determine a document type of the document using the document information. (Block 920) Subsequently, the method 900 may determine the preferred advertisement configuration associated with the determined document type. (Block 930) Finally, the method 900 may serve advertisements with the document in accordance with the determined preferred ad configuration (Block 940) before the method is left (Node 950).

Referring back to block 920, a document type might be derived from features of an input document using known and/or proprietary classification techniques. Document types might include, for example, news, blogs, forum, user rating, entertainment, search results, video search results, image search results, audio search results, e-mail search results, universal search results, gaming, social network, commerce and online encyclopedia (e.g., a WIKI), etc. A document type might be defined by an attribute value, and/or by a collection of attribute values.

Referring back to block 930, a document type might be derived from features of an input document using known and/or proprietary classification techniques. Document types might include news, blogs, forum, user rating, entertainment, search results, video search results, image search results, audio search results, e-mail search results, universal search results, gaming, social network, commerce and online encyclopedia (e.g., a WIKI), etc. A document type might be defined by an attribute value, and/or by a collection of attribute values.

### Exemplary Apparatus

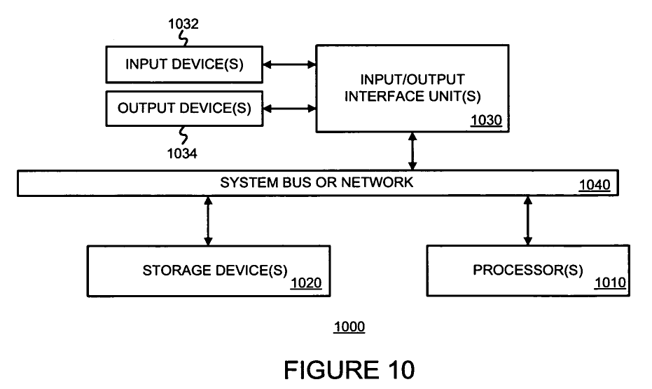

FIG. 10 is block diagram of a machine 1000 that may perform one or more of the operations and/or store the information described above. The machine 1000 may include one or more processors 1010, one or more input/output interface units 1030, one or more storage devices 1020, and one or more system buses and/or networks 1040 for facilitating the communication of information among the coupled elements. One or more input devices 1032 and one or more output devices 1034 may be coupled with the one or more input/output interfaces 1030. As described above, the operations 320, 330, 340, 350 and 360 of FIG. 3 might be modules of processor-executable instructions. The information 310, 315, 335, 345, 355 and 370 may be stored on a machine-readable (e.g., a computer-readable) storage medium or storage device.

The one or more processors 1010 may execute machine-executable instructions (e.g., C, C++, Java, JavaScript, AJAX, or other programming or scripting languages running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 1020 and/or may be received from an external source via one or more input interface units 1030.

In one embodiment, the machine 1000 may be one or more conventional personal computers. In this case, the processing units 1010 may be one or more microprocessors. The bus 1040 may include a system bus. The storage devices 1020 may include system memory, such as read only memory (ROM) and/or random access memory (RAM). The storage devices 1020 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1032, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 1010 through an appropriate interface 1030 coupled to the system bus 1040. The output devices 1034 may include a monitor or other type of display device, which may also be connected to the system bus 1040 via an appropriate interface. In addition to (or instead of) the monitor, the personal computer may include other (peripheral) output devices (not shown), such as speakers and printers for example.

The various operations described above may be performed by one or more machines 1000, and the various information described above may be stored on one or more machines 1000. The ad server 210, search engine 220, content server 230, e-mail server 240, and/or user device 250 may include one or more machines 1000.

### Alternatives And Extensions

Some embodiments consistent with the present invention might help the publisher of a Webpage to give the system more room to experiment with size of an ad block. Traditionally the publisher would specify the exact width and height of an ad block that they would like placed on their Webpage. Some embodiments consistent with the present invention might allow a publisher (e.g., a Webpage publisher) to specify maximum widths and heights by pixel count, by percentage of page, and/or by percentage of an html object such as a table row or column. Such embodiments might then test configurations of an ad block that use only the space that it needs to achieve the highest performance (e.g., estimated revenue per impression(s)). If the best configuration has unused space, such unused space might be “returned” to the publisher to be used on their page at its discretion.

As an alternative to the method 900 of FIG. 9, a determined ad configuration may be presented to the document owner (e.g., a Web publisher) before it is used to serve ads on its document. For example, such an alternative method might accept document information of a document of a Web publisher, determine a document type of the document using the document information, determine the preferred advertisement configuration associated with the determined document type, present a prototype document impression with advertisements or mock advertisements in accordance with the determined preferred ad configuration, accept Web publisher feedback with respect to the prototype document impression, and store the preferred advertisement configuration in association with the document if the Web publisher feedback indicates approval of the mock document impression. In some such embodiments, if the Web publisher feedback indicates disapproval of the mock document impression, then a next preferred advertisement configuration may be found using the determined document type, and the process may be repeated until the Web publisher feedback indicates approval of a mock document impression. Components (e.g., software modules and/or hardware) may be used to perform this alternative method.

### Conclusions

As can be appreciated from the foregoing, embodiments consistent with the present invention can be used to further improve ad serving decisions. In particular, at least some embodiments consistent with the present invention can determine and/or use an ad configuration that works well (or best) for a given document or a given type of document.

1. A computer-implemented method comprising:
a) serving, with different instances of a given document or of a document type, advertisements having different advertisement configurations;
b) tracking performance of the different advertisement configurations for at least one of the given document and document type;
c) determining, by a processor, a preferred advertisement configuration for at least one of the given document and document type, using the tracked performance of the different advertisement configurations; and
d) associating the determined preferred advertisement configuration with the at least one of a given document and document type.

2. The computer-implemented method of claim 1 wherein the given document or document type is a Web page.

3. The computer-implemented method of claim 1 wherein the given document or document type is one of (A) a news type document, (B) a blog type document, (C) a forum type document, (D) a search results type document, (E) a video search results type document, (F) an image search results type document, (G) an audio search results type document, (H) an e-mail results type document, (I) a universal search results type document, (J) a gaming type document, (K) a social network type document, (L) a commerce type document, (M) user rating, (N) entertainment and (O) an online encyclopedia type document.

4. The computer-implemented method of claim 1 wherein the tracked performance is normalized to remove the influence of general performance of the advertisements on the advertisement configuration performance.

5. The computer-implemented method of claim 1 wherein the tracked performance is per document impression revenue.

6. The computer-implemented method of claim 1 wherein the tracked performance is selection rate.

7. The computer-implemented method of claim 1 wherein the tracked performance is conversion rate.

8. The computer-implemented method of claim 1 wherein the advertisement configurations are constrained by a predefined advertisement block size.

9. The computer-implemented method of claim 1 wherein the advertisement configurations have different characteristics for at least one of (A) number of ads, (B) type of ads, (C) size of ad block, (D) background color, (E) background image, (F) text size, (G) text color, (H) font type, (I) border style, (J) border width, (K) border color, (L) length or size of creative, (M) whether to include maps, (N) whether to include accompanying images, (O) whether to include dynamic functionality, (P) whether to include interaction with other aspects of the ad block, (Q) whether to include particular video blocks, (R) whether to include particular audio blocks, (S) whether to include multimedia blocks of a particular length, and (T) whether to include particular executable code.

10. The computer-implemented method of claim 1, wherein the advertisement configurations have different characteristics for a type of ads, and the type of ads includes at least one of image, text, links, audio, video or multimedia.

11. The computer-implemented method of claim 1 wherein the advertisement configurations have different characteristics for a dynamic functionality and the dynamic functionality includes roll-over text and roll-over images.

12. The computer-implemented method of claim 1 wherein the advertisement configurations have different characteristics for an interaction with other aspects of the ad block and the interaction includes clicking links in one part of the ad block resulting in new ads in a different part of the ad block.

13. The computer-implemented method of claim 1 wherein the document type is a document configuration defined by at least one of (A) a genre of the content on the document, (B) placement of various ad blocks on the document, (C) dominant font type of the document, (D) background color of the document, (E) background image of the document, (F) dominant font color of the document, (G) dominant font size of the document, (H) number of images on the document, (I) total pixel count of images on the document, (J) size of each image on the document, (K) location of at least one other elements on the document, (O) whether the document includes video blocks, (P) whether the document includes audio blocks, (Q) whether the document is part of a game, (R) whether the document includes executable code, and (S) the technology used on the document.

14. The computer-implemented method of claim 1 wherein the document type is a document configuration defined by a genre of the content on the document and the genre includes at least one of news site, blog, forum, games, video, audio, broadcast multimedia content, a search result, video search results, an image search results, audio search results, an e-mail results, universal search results, gaming, social network, commerce and online encyclopedia.

15. The computer-implemented method of claim 1 wherein the document type is a document configuration defined by a placement of various ad blocks on the document and the placement of various ad blocks on the document includes at least one of above the fold, below the fold, left hand side, right hand side, top, bottom, within content, overplayed on content, and appended to content blocks.

16. The computer-implemented method of claim 1 wherein the document type is a document configuration defined by at least one other element and the at least one other element includes at least one of main navigation and main content.

17. The computer-implemented method of claim 1 wherein the document type is a document configuration defined by technology used on the document and the technology used on the document includes at least one of javascript, Macromedia Flash, video, MP3, audio, animated G1Fs, and other executable code.

18. The computer-implemented method of claim 1 further comprising:
e) accepting document information of a document to be provided with advertisements;
f) determining a document type of the document using the document information;
g) determining the preferred advertisement configuration associated with the determined document type; and
h) serving advertisements with the document in accordance with the determined preferred ad configuration.

19. The computer-implemented method of claim 1 further comprising:
e) accepting document information of a document of a Web publisher;
f) determining a document type of the document using the document information;
g) determining the preferred advertisement configuration associated with the determined document type;
h) presenting a prototype document impression with advertisements or mock advertisements in accordance with the determined preferred ad configuration;
i) accepting Web publisher feedback with respect to the prototype document impression with advertisements or mock advertisements; and
j) storing the preferred advertisement configuration in association with the document if the Web publisher feedback indicates approval of the prototype document impression with advertisements or mock advertisements.

20. The computer-implemented method of claim 19 further comprising:
k) if the Web publisher feedback indicates disapproval of the prototype document impression with advertisements or mock advertisements, then
determining a next preferred advertisement configuration using the determined document type,
presenting another prototype document impression with advertisements or mock advertisements in accordance with the determined preferred ad configuration, and
l) repeating acts (i)-(k) until the Web publisher feedback indicates approval of the another prototype document impression with advertisements or mock advertisements.

21. A computer-implemented method comprising:
a) accepting document information of a document to be provided with advertisements;
b) determining a document type of the document using the document information;
c) determining, by a processor, a preferred advertisement configuration based on the determined document type; and
d) serving advertisements with the document in accordance with the determined preferred ad configuration.

22. The computer-implemented method of claim 21 wherein the document is a Web page.

23. The computer-implemented method of claim 21 wherein the determined document type is selected from among a plurality of document types including (A) a news type document, (B) a blog type document, (C) a forum type document, (D) a search results type document, (E) a video search results type document, (F) an image search results type document, (G) an audio search results type document, (H) an e-mail results type document, (I) a universal search results type document, (J) a gaming type document, (K) a social network type document, (L) a commerce type document, (M) user rating, (N) entertainment and (O) an online encyclopedia type document.

24. The computer-implemented method of claim 21 wherein the act of determining a preferred ad configuration based on the determined document type includes using the determined document type to look up, in a stored data structure, a previously associated preferred ad configuration.

25. The computer-implemented method of claim 21 wherein the document type is a document configuration defined by at least one of (A) a genre of the content on the document, (B) placement of various ad blocks on the document, (C) dominant font type of the document, (D) background color of the document, (E) background image of the 5 document, (F) dominant font color of the document, (G) dominant font size of the document, (H) number of images on the document, (I) total pixel count of images on the document, (J) size of each image on the document, (K) location of at least one other elements on the document, (O) whether the document includes video blocks, (P) whether the document includes audio blocks, (Q) whether the document is part of a game, (R) whether the document includes executable code, and (S) the technology used on the document.

26. The computer-implemented method of claim 21 wherein the document type is a document configuration defined by a genre of the content on the document and the genre of the content on the document includes at least one of news site, blog, forum, games, video, audio, broadcast multimedia content, a search result, video search results, an image search results, audio search results, an e-mail results, universal search results, gaming, social network, commerce and online encyclopedia.

27. The computer-implemented method of claim 21 wherein the document type is a document configuration defined by placement of various ad blocks on the document and the placement of various ad blocks on the document includes at least one of above the fold, below the fold, left hand side, right hand side, top, bottom, and within content.

28. The computer-implemented method of claim 21 wherein the document type is a document configuration defined by at least one other element and at least one other element includes at least one of main navigation and main content.

29. The computer-implemented method of claim 21 wherein the document type is a document configuration defined by technology and the technology used on the document includes at least one of javascript, Macromedia Flash, video, MP3, audio, animated GIFs, and other executable code.

30. The computer-implemented method of claim 21 wherein the advertisement configurations have different characteristics for at least one of (A) number of ads, (B) type of ads, (C) size of ad block, (D) background color, (E) background image, (F) text size, (G) text color, (H) font type, (I) border style, (J) border width, (K) border color, (L) length or size of creative, (M) whether to include maps, (N) whether to include accompanying images, (O) whether to include dynamic functionality, (P) whether to include interaction with other aspects of the ad block, (Q) whether to include particular video blocks, (R) whether to include particular audio blocks, (S) whether to include multimedia blocks of a particular length, and (T) whether to include particular executable code.

31-38. (canceled)

39. Apparatus comprising:
memory storing:
a) an experimental serving component for serving, with different instances of a given document of a document type, advertisements having different advertisement configurations;
b) a performance tracking component for tracking performance of the different advertisement configurations for at least one of the given document and document type; and
c) a preferred ad configuration determination component for (1) determining a preferred advertisement configuration for at least one of the given document and document type, using the tracked performance of the different advertisement configurations, and (2) associating the determined preferred advertisement configuration with the at least one of a given document and document type; and
a processor coupled to the memory and operable to manage the experimental serving component, the performance tracking component, and the preferred ad configuration determination component.

40. The apparatus of claim 39, wherein the memory further stores:
d) an ad confirmation determination component for (1) accepting document information of a document to be provided with advertisements, (2) determining a document type of the document using the document information, (3) determining the preferred advertisement configuration associated with the determined document type; and
e) an ad serving component for serving advertisements with the document in accordance with the determined preferred ad configuration; and
wherein the processor is further operable to manage the ad confirmation determination component and the ad serving component.

41. The apparatus of claim 39, wherein the memory further stores:
d) an ad confirmation determination component for (1) accepting document information of a document of a Web publisher, (2) determining a document type of the document using the document information, and (3) determining the preferred advertisement configuration associated with the determined document type; and
e) a Web publisher user interface component for (1) presenting a prototype document impression with advertisements or mock advertisements in accordance with the determined preferred ad configuration, (2) accepting Web publisher feedback with respect to the prototype document impression with advertisements or mock advertisements, and
f) a storage component for storing the preferred advertisement configuration in association with the document if the Web publisher feedback indicates approval of the prototype document impression with advertisements or mock advertisements; and
wherein the processor is further operable to manage the ad confirmation determination component, the Web publisher user interface component, and the storage component.

42. Apparatus comprising:
memory storing:
a) an ad confirmation determination component adapted to (1) accept document information of a document to be provided with advertisements, (2) determine a document type of the document using the document information, and (3) determining a preferred advertisement configuration based on the determined document type; and
b) an ad serving component adapted to serve advertisements with the document in accordance with the determined preferred ad configuration; and
a processor coupled to the memory and configured to manage the ad confirmation determination component and the ad serving component.

43. A tangible computer-readable storage medium on which computer readable instructions of a program are stored, the instructions, when executed by a processor, cause the processor to perform a method, the method comprising:
a) serving, with different instances of a given document or of a document type, advertisements having different advertisement configurations;
b) tracking performance of the different advertisement configurations for at least one of the given document and document type;
c) determining, by a processor, a preferred advertisement configuration for at least one of the given document and document type, using the tracked performance of the different advertisement configurations; and
d) associating the determined preferred advertisement configuration with the at least one of a given document and document type.

44. The tangible computer-readable storage medium of claim 1, wherein the method further comprises:
e) accepting document information of a document to be provided with advertisements;
f) determining a document type of the document using the document information;
g) determining the preferred advertisement configuration associated with the determined document type; and
h) serving advertisements with the document in accordance with the determined preferred ad configuration.

45. The tangible computer-readable storage medium of claim 43, wherein the method further comprises:
e) accepting document information of a document of a Web publisher;
f) determining a document type of the document using the document information;
g) determining the preferred advertisement configuration associated with the determined document type;
h) presenting a prototype document impression with advertisements or mock advertisements in accordance with the determined preferred ad configuration;
i) accepting Web publisher feedback with respect to the prototype document impression with advertisements or mock advertisements; and
j) storing the preferred advertisement configuration in association with the document if the Web publisher feedback indicates approval of the prototype document impression with advertisements or mock advertisements.

46. The computer-implemented method of claim 45, wherein the method further comprises:
k) if the Web publisher feedback indicates disapproval of the prototype document impression with advertisements or mock advertisements, then
determining a next preferred advertisement configuration using the determined document type,
presenting another prototype document impression with advertisements or mock advertisements in accordance with the determined preferred ad configuration and
l) repeating acts (i)-(k) until the Web publisher feedback indicates approval of the another prototype document impression with advertisements or mock advertisements.

47. The tangible computer-readable storage medium of claim 43, wherein the given document or document type is one of (A) a news type document, (B) a blog type document, (C) a forum type document, (D) a search results type document, (E) a video search results type document, (F) an image search results type document, (G) an audio search results type document, (H) an e-mail results type document, (I) a universal search results type document, (J) a gaming type document, (K) a social network type document, (L) a commerce type document, (M) user rating, (N) entertainment and (O) an online encyclopedia type document.

48. The tangible computer-readable storage medium of claim 43, wherein the tracked performance is normalized to remove the influence of general performance of the advertisements on the advertisement configuration performance.

49. The tangible computer-readable storage medium of claim 43, wherein the tracked performance is conversion rate.

50. The tangible computer-readable storage medium of claim 43, wherein the advertisement configurations have different characteristics for at least one of (A) number of ads, (B) type of ads, (C) size of ad block, (D) background color, (E) background image, (F) text size, (G) text color, (H) font type, (I) border style, (J) border width, (K) border color, (L) length or size of creative, (M) whether to include maps, (N) whether to include accompanying images, (O) whether to include dynamic functionality, (P) whether to include interaction with other aspects of the ad block, (Q) whether to include particular video blocks, (R) whether to include particular audio blocks, (S) whether to include multimedia blocks of a particular length, and (T) whether to include particular executable code.
